(19) United States
(12) Patent Application Publication
(10) Pub. No.: US 2014/0068499 A1
(43) Pub. Date: Mar. 6, 2014

(54) METHOD FOR SETTING AN EDIT REGION AND AN ELECTRONIC DEVICE THEREOF

(71) Applicant: Samsung Electronics Co., Ltd., Gyeonggi-do (KR)

(72) Inventors: Hyung-Seoung YOO, Gyeonggi-do (KR); Chan-Ki Jo, Gyeonggi-do (KR)

(73) Assignee: Samsung Electronics Co., Ltd., Gyeonggi-do (KR)

(21) Appl. No.: 14/012,361

(22) Filed: Aug. 28, 2013

(30) Foreign Application Priority Data
Aug. 28, 2012 (KR) 10-2012-0094266

(51) Int. Cl. G06F 3/0484

(52) U.S. Cl. CPC G06F 3/0484
USPC 715/781

(57) ABSTRACT

An apparatus and method for determining an edit region for an output screen by detecting a user input in an electronic device having a touch screen are provided. The method of determining the edit region of the output screen in the electronic device includes detecting a user input of at least two points on the output screen, and determining the edit region as a function of the points on which the user input is detected.

### PRIORITY

This application claims priority under 35 U.S.C. §119(a) to a Korean patent application Serial No. 10-2012-0094266 filed in the Korean Intellectual Property Office on Aug. 28, 2012, the entire disclosure of which is incorporated herein by reference.

### BACKGROUND OF THE INVENTION

1. Field of the Invention

The present invention generally relates to an apparatus and method for determining a region for an output screen, and more particularly an apparatus and method for determining a region for an output screen by detecting a user input in an electronic device having a touch screen.

2. Description of the Related Art

Electronic devices have become a necessity of modern life due to ease of portability, and are being developed into multimedia devices for providing various services such as audio and video telephony functions, information input and output functions, and data storage functions.

The amount of information to be processed and the amount of information to be displayed have increased since electronic devices provide multimedia service. Accordingly, there is a growing interest in an electronic device having a touch screen capable of increasing a size of a display unit by improving space utilization.

The touch screen is an input and display unit which inputs and displays information in one screen. Accordingly, when using the touch screen, the electronic device can increase a display area by removing an additional input unit such as a keypad. For example, when using a full touch mechanism which applies the touch screen to an entire screen, a screen size can be increased by using a front surface of the electronic device as a screen.

In addition, the electronic device using the touch screen can write text or draw a line by using an input tool such as a stylus pen or an electronic pen. Accordingly, the user can edit an output image in various manners.

One of the representative image editing methods is a crop method which acquires only a part of a full image.

To crop an image, the electronic device outputs an edit region which designates a part to be cropped and thereafter acquires a partial image (i.e., an image included in the edit region) at a position desired by a user.

However, the electronic device determines the edit region by detecting an input of a user who must navigate through a plurality of service menus.

For example, a user determines an edit region to crop a certain region of an image stored in a gallery. To perform such a process, the user selects and loads an image to be edited and thereafter selects a crop menu from among service menus of an image viewer. Accordingly, when it is detected that the crop menu is selected by the user, the electronic device outputs the edit region at a center of the current output screen and can subsequently change a size and location of the output edit region according to a user input.

As described above, there is a problem in that the user of the electronic device must perform the process of selecting the service menu to determine the edit region.

In addition, although the user can store the cropped image separately or can store the cropped image into a clipboard, there is a problem in that the user must navigate through a plurality of service menus to perform such an operation.

Conventionally, the electronic device uses a process in which the user must navigate through a plurality of menus to determine the edit region or perform a data selection process.

For example, the user determines the edit region to crop a part of an image stored in a gallery. In order to perform such a process, the user selects and loads an image to be edited, and thereafter selects a crop menu from service menus of an image viewer. Accordingly, if it is detected that a crop menu is selected by the user, the electronic device outputs the edit region in a center of the current output screen, and can change a size and location of the edit region which has already been output according to the user input. Such an edit region determining mechanism is equally applied in a web screen.

In addition, in order to perform a process of deleting, copying, and sharing an image file, the user outputs a list of the image file and thereafter selects a data selection menu from the service menus of the image viewer. Accordingly, the electronic device activates a check box for each image file, and selects a check box of the image file to be selected. That is, the electronic device recognizes the check box as the image file selected by the user.

When the user determines an edit region or selects data as described above, there is a problem in that the user must perform the process of navigating through the plurality of menus.

With regards to text data, a user outputs the text data on the screen of the electronic device to confirm the content of the e-book, news, etc. In addition, the user can copy a desired part from the output text or can send the part to another user.

In order to perform such a process, the user performs an additional input process (i.e., a menu selection process) to select an edit region. The edit region for the text data is determined as a region around a text on which a user input is detected, and the user controls the edit region by using an additional input process. For example, the electronic device outputs the edit region for the text on which the user input is detected, and the user must determine a range of the edit region desired by the user by selecting a control bar of the edit region.

With regards to media data, a user selects a part of data from a media data list to move or copy it to another storage space. In addition, the user selects media data to delete or to share it with other users.

In order to perform such a process, the user selects a service menu which enables a data selection to activate a check box for detecting a user selection for each image file. Thereafter, the user selects a check box of an image file to be selected, and thus selects data to be moved, deleted, shared, copied, etc.

### SUMMARY OF THE INVENTION

The present invention has been made to address at least the problems and disadvantages described above, and to provide at least the advantages described below. Accordingly, aspects of the present invention provides an apparatus and method for determining an edit region by detecting a user input for an output screen in an electronic device.

Another aspect of the present invention is to provide an apparatus and method for performing a process of selecting a plurality of pieces of data by determining an edit region in an electronic device.

Another aspect of the present invention is to provide an apparatus and method for changing a size and location of an edit region in an electronic device.

Another aspect of the present invention is to provide an apparatus and method for determining an edit region in various shapes in an electronic device.

Another aspect of the present invention is to provide an apparatus and method for controlling data of an edit region by detecting a movement of the edit region in an electronic device.

According to an aspect of the present invention, a method of determining an edit region of an output screen in an electronic device is provided. The method includes detecting a user input including at least two points on the output screen, and determining the edit region as a function of the points on which the user input is detected.

According to another aspect of the present invention, an apparatus for determining an edit region of an output screen in an electronic device is provided.

The apparatus includes at least one processor, a memory, and at least one program stored in the memory and configured to be executable by the at least one processor, wherein the program includes an instruction for detecting a user input including at least two points on the output screen and for determining the edit region as a function of the points on which the user input is detected.

According to another aspect of the present invention, a non-transitory computer-readable storage medium for storing one or more programs, if performed by an electronic apparatus, is provided. The program includes instructions for detecting a user input including at least two points on the output screen, and determining the edit region as a function of the points on which the user input is detected.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a structure of an electronic device for performing a process of determining an edit region according to an embodiment of the present invention;

FIG. 2 is a flowchart illustrating a process of controlling an output screen in an electronic device according to an embodiment of the present invention;

FIG. 3 is a flowchart illustrating a process of controlling an output screen in an electronic device according to an embodiment of the present invention;

FIGS. 4A-4C illustrate a process of determining an edit region of an electronic device according to an embodiment of the present invention;

FIGS. 5A-5D illustrate a process of determining an edit region of an electronic device according to an embodiment of the present invention;

FIGS. 6A-6D illustrate a process of determining an edit region of an electronic device according to an embodiment of the present invention;

FIGS. 7A-7C illustrate a process of editing data of an electronic device according to an embodiment of the present invention;

FIGS. 8A-8B illustrate a screen which determines an edit region of an electronic device according to an embodiment of the present invention;

FIGS. 9A-9C illustrate a shape of an edit region which can be determined in an electronic device according to an embodiment of the present invention;

FIGS. 10A-10F illustrate a screen which performs a process of editing an image in an electronic device according to an embodiment of the present invention;

FIGS. 11A-11D illustrate a screen which controls a size of an edit region in an electronic device according to an embodiment of the present invention;

FIGS. 12A-12C illustrate a screen which controls data of an edit region in an electronic device according to an embodiment of the present invention;

FIGS. 13A-13C illustrate a screen which controls a size of an edit region in an electronic device according to an embodiment of the present invention;

FIGS. 14A-14-B illustrate a screen which controls an edit region in an electronic device according to an embodiment of the present invention;

FIGS. 15A-15D illustrate a screen which zooms in on an edit region in an electronic device according to an embodiment of the present invention; and

FIGS. 16A-16C illustrate a screen which reverses an edit region in an electronic device according to an embodiment of the present invention.

### DETAILED DESCRIPTION OF EMBODIMENTS OF THE PRESENT INVENTION

Embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein. Further, like reference numerals denote parts performing similar functions and actions throughout the drawings.

The present invention described hereinafter relates to an apparatus and method for determining an edit region by using a plurality of input points in an electronic device according to the present invention. Herein, the plurality of input points imply a point at which a multi-touch input is generated on a touch screen, a point at which a touch input is consecutively generated for a specific time period, etc.

In this case, the electronic device avoids a process of selecting a plurality of menus to determine the edit region, and preferably can perform a data editing process and a data selecting process by using the edit region.

In addition, the edit region corresponds to a data editing range and a data selecting range, and is applicable to an image crop, an image copy, an image zoom-in, a selection of data belonging to an album, etc.

In addition, the electronic device may be a portable electronic device. Further, the electronic device may be, for example, a portable terminal, a mobile phone, a media player, a tablet computer, a handheld computer, or a Personal Digital Assistant (PDA). It should be noted, however, that the electronic device may be any portable electronic device including, for example, a device which combines two or more functions among the above-listed devices.

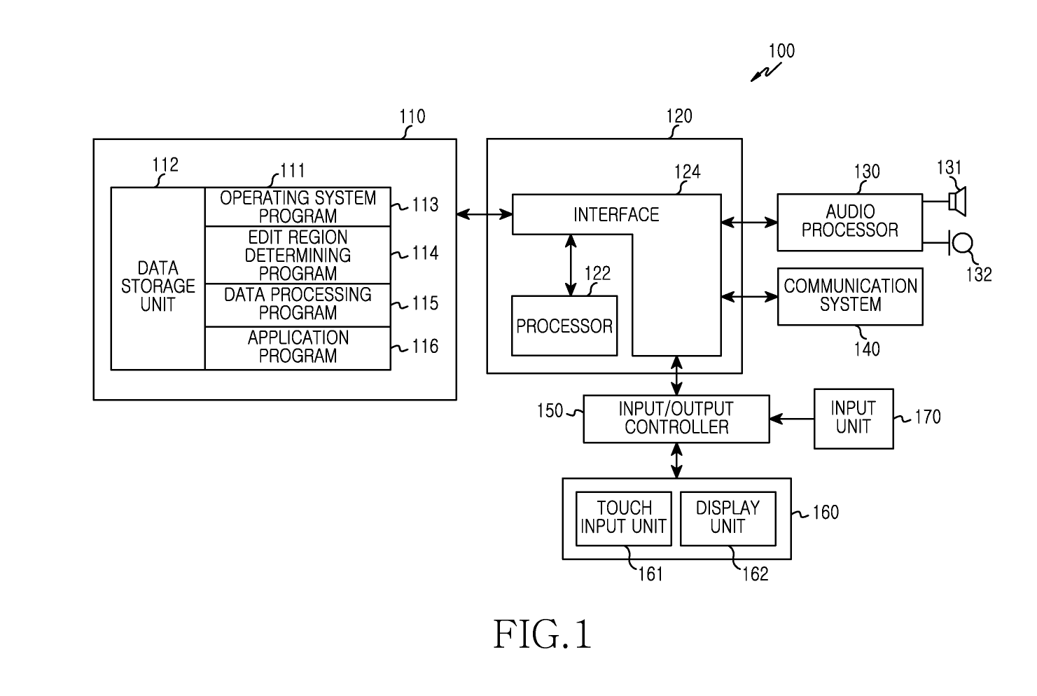

FIG. 1 is a block diagram illustrating a structure of an electronic device for performing a process of determining an edit region according to an embodiment of the present invention.

Referring to FIG. 1, an electronic device 100 includes a memory 110, a processor unit 120, an audio processor 130, a communication system 140, an input/output controller 150, a touch screen 160, and an input unit 170. It should be noted that the electronic device 100 may include more than one of the memory 110 and the communication system 140.

The memory 110 includes a program storage unit 111 for storing a program for controlling an operation of the electronic device 100 and a data storage unit 112 for storing data generated during the execution of the program. For example, the data storage unit 112 stores a variety of rewritable data, such as phonebook entries, outgoing messages, incoming messages, etc., and according to the present invention, stores information on an edit region control mechanism and an edit region type list that can be determined in the electronic device 100. Herein, the edit region control mechanism refers to a user input mechanism for controlling data of the edit region, and for example, may be information on a direction in which the edit region is moved to crop data included in the edit region or to store the data into a clipboard. That is, if data in the edit region is cropped by moving the edit region to the left, the edit region control mechanism corresponds to a movement to the left.

In addition, the program storage unit 111 includes an operating system program 113, an edit region determining program 114, a data processing program 115, and at least one application program 116. Herein, the program included in the program storage unit 111 is a set of instructions, and can be expressed as an instruction set.

The operating system program 113 includes various software components for controlling a general system operation. The control of the general system operation implies, for example, memory management and control, storage hardware (device) control and management, power control and management, etc. The operating system program 113 also performs a function of facilitating communication between various hardware (device) and program components (module).

The edit region determining program 114 includes at least one software component for handling the determination of an edit region corresponding to a user input detected on an output screen. That is, upon detection of a user input for at least two points, the edit region determining program 114 determines an edit region passing through the points on which the user input is detected. In this case, the edit region determining program 114 can determine an edit region in a shape of a quadrilateral having a diagonal line connecting the two points on which the user input is detected. In another example, the edit region determining program 114 can determine an edit region in a shape of a triangle having a side connecting the two points on which the user input is detected. In addition, the edit region determining program 114 can determine an edit region in a shape of a circle having a diameter or radius connecting the two points on which the user input is detected. That is, the edit region determining program 114 can determine an edit region in various shapes passing through the two points on which the user input is detected. The shape of the edit region may be determined by a user.

In addition, after determining the edit region, the edit region determining program 114 can zoom in or out on a predetermined edit region by detecting a user input. In this case, the edit region determining program 114 can zoom in or out on the edit region by maintaining or changing the shape of the predetermined edit region.

The data processing program 115 includes at least one software component for controlling the processing of data included in the edit region which is determined according to the user input detected on the output screen.

The data processing program 115 crops data included in the edit region and/or stores the data into a clipboard. In addition, the data processing program 115 can zoom in or out on the data included in the edit region. In addition, the data processing program 115 can recognize only the data included in the edit region and selected from a plurality of data lists as data selected by the user. The data processing program 115 can perform an application operation corresponding to a movement direction of the edit region by associating the edit region with the application.

The application program 116 includes a software component for at least one application program installed in the electronic device 100. The application program 116 may include an image viewer, an image edit program, a music player for managing a plurality of pieces of data, an image gallery, etc., by which the edit region can be determined according to the method of the present invention.

The processor unit 120 includes at least one processor 122 and an interface 124. Herein, the processor 122 and the interface 124 may be integrated as at least one integrated circuit or may be implemented as separate components.

The interface 124 serves as a memory interface for controlling an access of the processor 122 and the memory 110.

In addition, the interface 124 serves as a peripheral device interface for controlling a connection of the processor 122 and an input/output peripheral device of the electronic device 100.

The processor 122 controls the electronic device 100 to determine the edit region by using at least one software program. In this case, the processor 122 executes at least one program stored in the memory 110 to determine the edit region corresponding to the program. For example, the processor 122 may include an image editing processor for determining the edit region and for processing data of the edit region. That is, the determining of the edit region of the electronic device 100 may be performed in software such as a program stored in the memory 110 or in hardware such as the image editing processor.

The audio processor 130 provides an audio interface between the user and the electronic device 100 via a speaker 131 and a microphone 132.

The communication system 140 performs a communication function for voice communication and data communication of the electronic device 100. In this case, the communication system may be divided into a plurality of communication sub-modules for supporting different communication networks. For example, although not limited thereto, the communication network may include a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Local Area Network (WLAN), a Bluetooth network, Near Field Communication (NFC), etc.

The input/output controller 150 provides an interface between an input/output device (e.g., the touch screen 160, the input unit 170, etc.) and the interface 124.

The touch screen 160 is an input/output device for detecting input information and displaying output information, and includes a touch input unit 161 and a display unit 162.

The touch input unit 161 provides touch information sensed via a touch panel to the processor unit 120 via the input/output controller 150. In this case, the touch input unit 161 provides the touch information to the processor unit 120 by changing the information in an instruction format such as, for example, touchdown, touch_move, and touch_up.

The display unit 162 displays status information of the electronic device 100, a character input by the user, a moving picture, a still picture, etc. For example, the display unit 162 may display an edit region determining procedure and a data processing procedure included in the edit region.

The input unit 170 provides input data generated by a selection of the user to the processor unit 120 via the input/output controller 150. For example, the input unit 170 may include only control buttons for the control of the electronic device 100. In another example, the input unit 170 may consist of a key pad for receiving a data input from the user. The input unit 170 generates a user input for determining the edit region on the output screen according to the present invention.

Although not shown, the electronic device 100 may further include other components for providing an additional functions such as a camera module for image or video capture, a broadcast receiving module for broadcast reception, a digital sound source reproducing module such as an MP3 module, a near field communication module for near field communication, a proximity sensor for proximity sensing, etc., and a software element for operating the components.

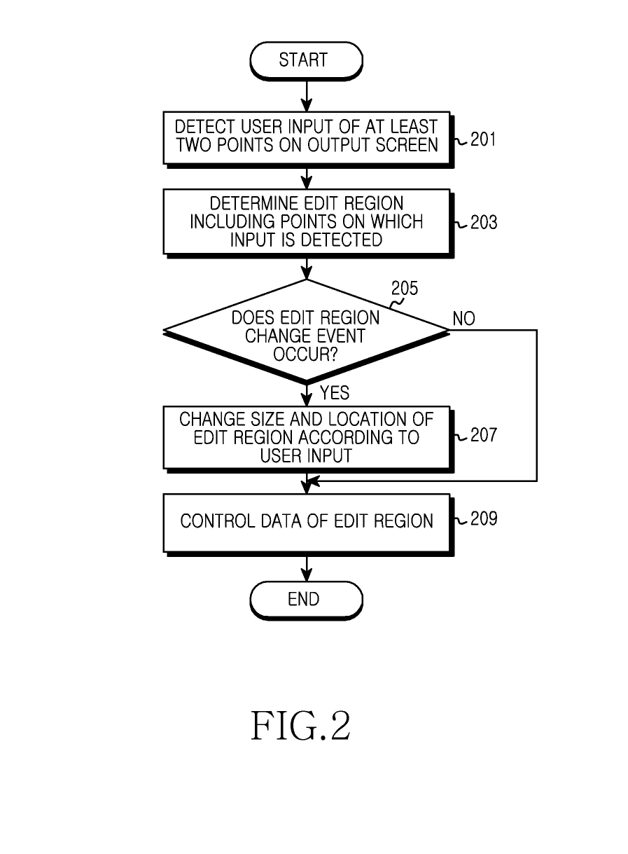

FIG. 2 is a flowchart illustrating a process of controlling an output screen in an electronic device according to an embodiment of the present invention.

Referring to FIG. 2, the electronic device can determine an edit region to perform an editing process such as cropping a part of an output image, storing it into a clipboard, etc. Furthermore, the electronic device can determine the edit region to select some of a plurality of pieces of data of a media player. In this manner, the electronic device recognizes data included in the edit region as data selected by a user.

The electronic device for determining the edit region as described above may perform an image editing function or may be in a state in which a list for a plurality of pieces of data is output.

In step 201, the electronic device detects a user input of at least two points on an output screen. In step 203, the electronic device determines an edit region including the points on which the input is detected.

In this case, the electronic device determines the edit region passing through the points on which the user input is detected on the output screen, and can determine an edit region in a shape of, for example, a quadrilateral having a diagonal line connecting the two points or a triangle having a side connecting the two points. Furthermore, the electronic device can determine an edit region in a shape of a circle having a diameter or radius connecting the two points. Upon detection of a user input for three points, the electronic device can determine an edit region in a shape of a triangle having vertices corresponding to the respective three points. Upon detection of a user input for a plurality of points, the electronic device can determine an edit region in an asymmetric shape consisting of lines connecting the respective points.

In step 205, the electronic device determines whether an edit region change event occurs. The edit region change event occurs when an input for changing a size, location, etc., of an edit region is generated by a user input for an output screen.

If it is determined in step 205 that the edit region change event does not occur, the method proceeds to step 209, and the electronic device controls data of the edit region. Herein, the controlling of the data of the edit region is an operation of selecting, zooming, cropping, and storing the data included in the edit region, storing the data into a clipboard, etc.

The electronic device can perform a control operation corresponding to a user input for a predetermined edit region. For example, when it is determines that the edit region is moved to a specific location, the electronic device may crop the data included in the edit region or can output a list of a control operation (e.g., a crop, a copy, an attachment to a message, etc.).

If it is determined in step 205 that the edit region change event occurs, the method proceeds to step 207, and the electronic device changes the edit region according to a size and location corresponding to a user input.

In step 209, the electronic device controls data of the edit region changed by the user input, at which point the method of FIG. 2 ends.

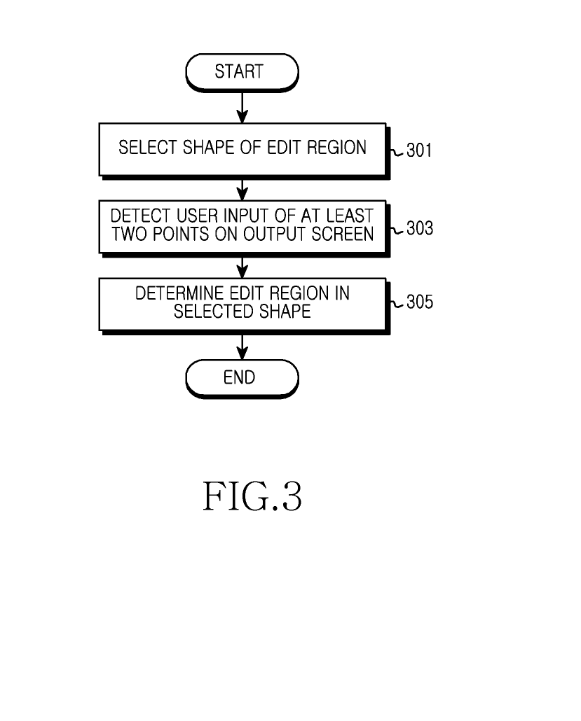

FIG. 3 is a flowchart illustrating a process of controlling an output screen in an electronic device according to another embodiment of the present invention.

Referring to FIG. 3, the electronic device selects a shape of an edit region in step 301. As described above, the electronic device can determine the edit region in various shapes such as a triangle, a quadrilateral, a circle, etc. Accordingly, the electronic device can output a list of shapes of the edit region that can be determined, and thereafter selects a shape desired by the user.

Thereafter, the electronic device detects a user input of at least two points on an output screen in step 303, and then determines, in step 305, an edit region including the points on which the input is detected. In this case, the electronic device determines an edit region having a shape selected in step 301.

For example, if the user selects a circular shape, the electronic device can determine an edit region in a shape of a circle having a diameter or radius connecting points on which the user input is detected or can determine the circular shaped edit region by using a curve passing the two points. In addition, if the user selects a triangular shape, the electronic device can select an edit region in a shape of a triangle having a diagonal line connecting the points on which the user input is detected. Upon detection of a user input for three points, the electronic device can determine an edit region in a shape of a triangle having vertices corresponding to the respective three points.

In addition, upon detection of an additional user input in a state in which the edit region is determined, the electronic device can zoom in or out the edit region according to the additional user input while maintaining a pre-selected shape.

As such, the electronic device determines the edit region in a shape selected by the user and then the procedure of FIG. 3 ends.

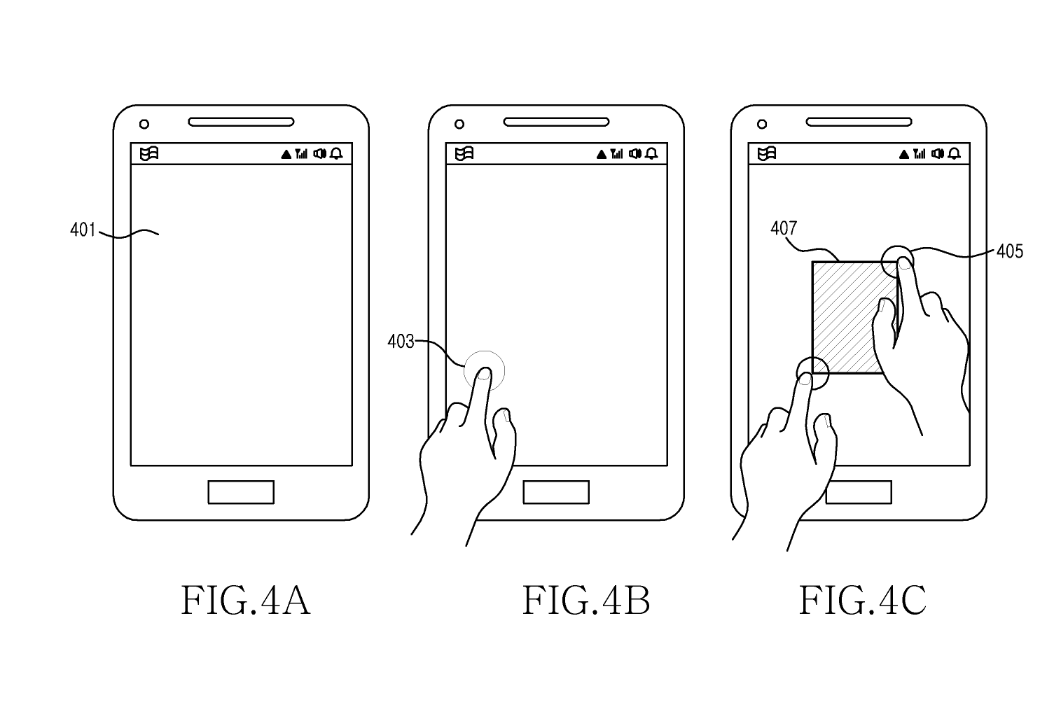

FIGS. 4A-4C illustrate a process of determining an edit region of an electronic device according to an embodiment of the present invention.

Referring to FIG. 4A, the electronic device outputs a screen 401 to which the edit region is applied. In this case, the screen 401 output by the electronic device may be, for example, a screen on which an edit application is executed. In addition, the screen 401 output by the electronic device may be, for example, a screen which outputs a data list. In addition, the screen 401 output by the electronic device may be, for example, a screen on which a web browser, an e-book application, etc., are executed.

The electronic device of the present invention can determine an edit region on the basis of at least one user input point detected on an output screen, and can perform an editing process in which the output screen is copied or cropped by using the determined edit region. In addition, the electronic device can select data included in the edit region as a target of the editing process.

More specifically, the electronic device detects a user input 403 which is used as a reference for determining the edit region as illustrated in FIG. 4B. The user of the electronic device can directly determine the edit region, and thus can define a reference location of the edit region to be determined. In this case, the user can determine the edit region including the reference location and subsequent consecutive input locations.

Upon detection of the user input as described above, the electronic device detects an additional user input 405 for requesting the determination of the edit region as illustrated in FIG. 4C. Herein, the edit region can be determined upon detection of a user input of at least two points. Accordingly, a user input for requesting the determination of the edit region may be an additional input which is consecutively detected after a reference user input.

For example, if the user determines the edit region by using an input for two points, an input 1 (i.e., a first input) implies the reference user input, and an input 2 (i.e., a second input) implies a user input for requesting the determination of the edit region.

In another example, if the user determines the edit region by using an input for three points, an input 1 (i.e., a first input) implies the reference user input, and an input 2 (i.e., a second input) implies a user input for requesting the determination of the edit region, and an input 3 (i.e., a third input) implies a user input for requesting the determination of the edit region.

As illustrated in FIG. 4C, an edit region 407 is determined on a screen by using the user inputs 403 and 405 for two points on the touch screen.

The edit region is determined according to a user input point as described above. For example, if two points are touched as the user input, the edit region may have a shape of a quadrilateral having a diagonal line connecting the two points. In addition, the edit region may have a shape of a circle having a diameter connecting the two points.

In another example, if three points are touched as the user input, the edit region may have a shape of a circle passing through the three points. In addition, the edit region may have a shape of a triangle or quadrilateral passing through the three points.

The edit region of the present invention is determined according to the user input point detected on the touch screen, and is not limited to the aforementioned shapes and thus can be expressed in different ways.

In addition, upon detection of an additional user input in a state in which the edit region has already been determined, the electronic device can change a predetermined shape of the edit region according to the detected user input. In doing so, when the user fails to determine a desired edit region by using the touch input, the predetermined edit region can be zoomed in or out by changing an input location without having to repeat the aforementioned process from the beginning.

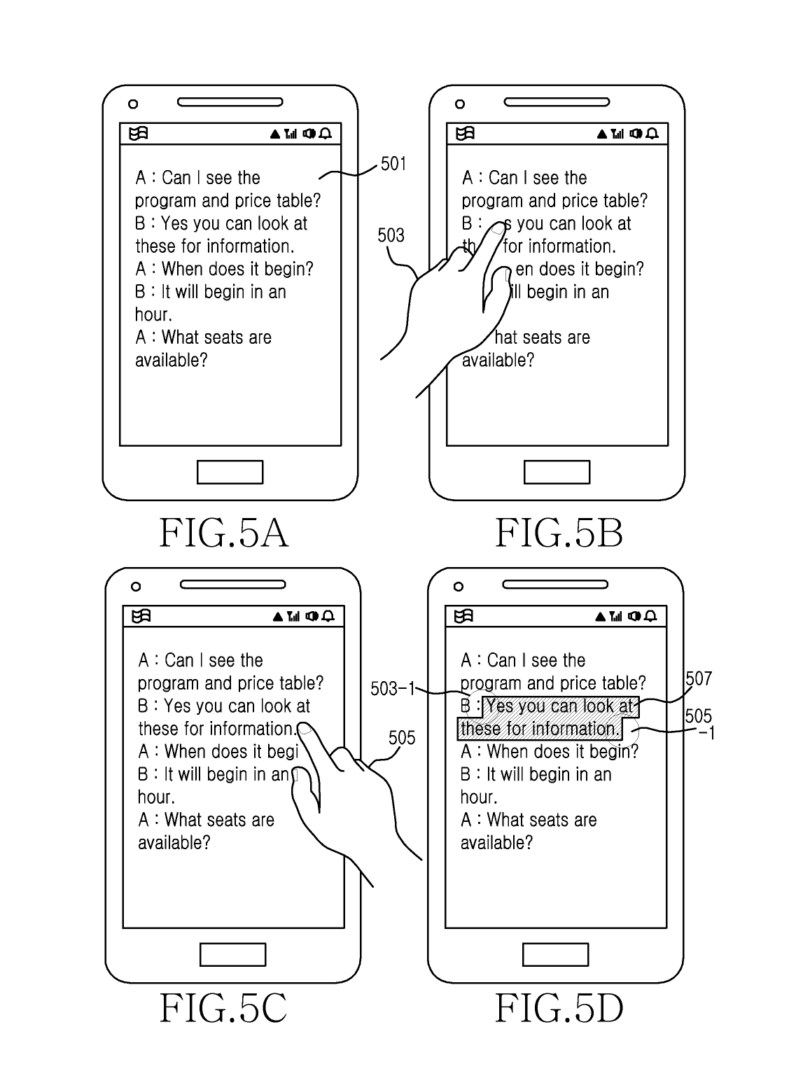

FIGS. 5A-5D illustrate a process of determining an edit region of an electronic device according to an embodiment of the present invention.

FIG. 5A illustrates a screen 501 which outputs text data in the electronic device of the present invention. Herein, the screen which outputs the text data may be a state in which an e-book viewer, a web browser, etc., are executed.

The electronic device of the present invention determines the edit region by using a plurality of user input points detected on an output screen. Such an electronic device uses the user input point as a range for determining the edit region.

As illustrated in FIG. 5B, in order to perform the aforementioned operation, the electronic device detects a user input 503 which is used as a reference for determining the edit region. The user of the electronic device can directly determine the edit region, and thus can define a reference location of the edit region to be determined. In this case, the user can determine the edit region including the reference location and subsequent consecutive input locations.

As illustrated in FIG. 5C, upon detection of the user input as described above, the electronic device detects an additional user input 505 for requesting the determination of the edit region. Herein, the edit region can be determined upon detection of a user input for at least two points. Accordingly, a user input for requesting the determination of the edit region may be an additional input which is consecutively detected after a reference user input.

As illustrated in FIG. 4, the electronic device of the present invention can determine an edit region including a plurality of user inputs or an edit region having a diagonal line connecting two input points.

However, the edit region can also be determined in a different manner in a state in which the text data is output. This is because the text data may be a sentence consisting of a plurality of words, a space, etc. Such sentences may be gathered to form a long paragraph, and if the edit region is determined as described above with reference to FIG. 4, a part of consecutively input words, a sentence, etc., may be out of the edit region.

In order to solve such a problem, the electronic device of the present invention can define a word, sentence, etc., included between points on which the user input is detected as the edit region.

For example, the electronic device may detect an input 1 (i.e., first input) of the user and define it as a start point 503-1 of the edit region, and may detect an input 2 (i.e., second input) and define it as an end point 505-1 of the edit region.

Thereafter, the electronic device defines text data included in a region between a start point and an end point of an edit region in a text data input direction as an edit region 507.

That is, as illustrated in FIG. 5D, the electronic device determines the edit region 507 to be a region between two points input by the user, and the user can use this region to perform an editing process (i.e., copying of data included in the edit region) for text data included in a range of the edit region.

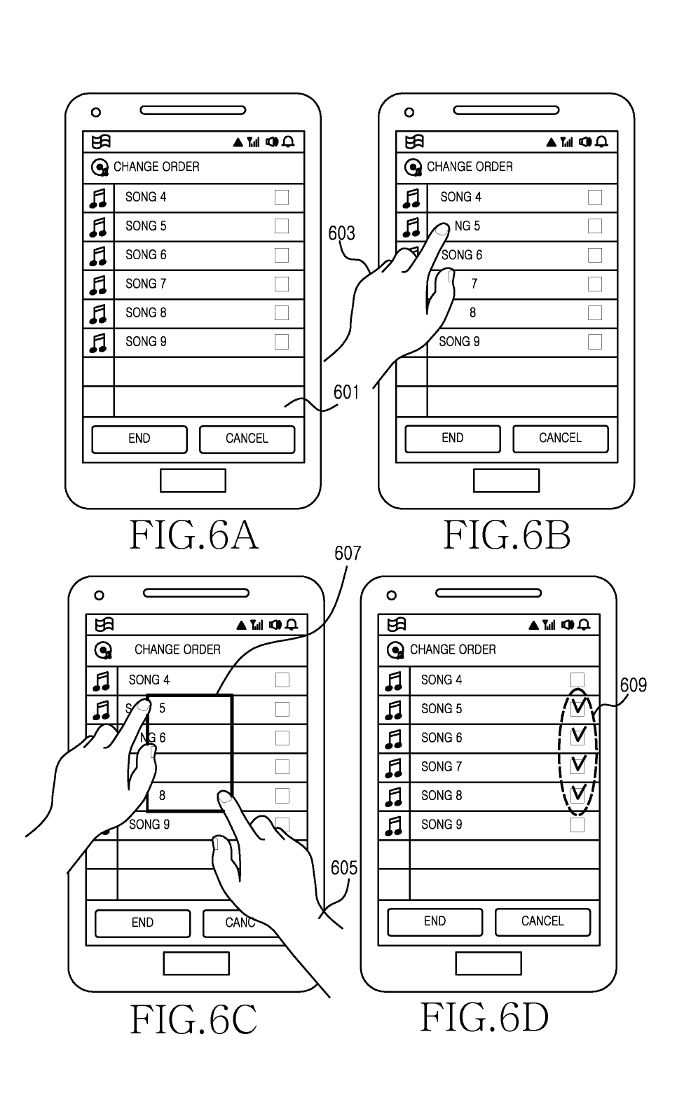

FIGS. 6A-6D illustrate a process of determining an edit region of an electronic device according to an embodiment of the present invention.

FIG. 6A illustrates a screen which outputs a media data list 601 in an electronic device of the present invention.

Herein, the screen which outputs the media data list 601 may be a screen of an electronic device for performing an image viewer, a media player, etc.

The electronic device of the present invention determines an edit region by using a plurality of detected user input points. The electronic device may define media data included in the edit region as data selected by the user.

As illustrated in FIG. 6B, in order to perform the aforementioned operation, the electronic device detects a user input 603 which is used as a reference for determining the edit region. The user of the electronic device can directly determine the edit region, and thus can define a reference location of the edit region to be determined. In this case, the user can determine the edit region including the reference location and subsequent consecutive input locations.

As illustrated in FIG. 6C, upon detection of the user input as described above, the electronic device detects an additional user input 605 for requesting the determination of the edit region, and thereafter determines an edit region 607 corresponding to a detected user input. Herein, the edit region can be determined upon detection of a user input of at least two points. Accordingly, a user input for requesting the determination of the edit region may be an input which is consecutively detected after a reference user input.

As illustrated in FIG. 4, the electronic device of the present invention can determine an edit region including a plurality of user inputs or an edit region having a diagonal line connecting two input points.

Of course, if media data is written in a horizontal direction, the electronic device can determine a region between points on which a user input is detected as an edit region as illustrated in FIG. 5.

That is, the electronic device determines an edit region corresponding to a user input point as illustrated in FIG. 6D, and can determine data included in the determined edit region as data selected by a user and thus can display an output for indicating that the data is selected (609).

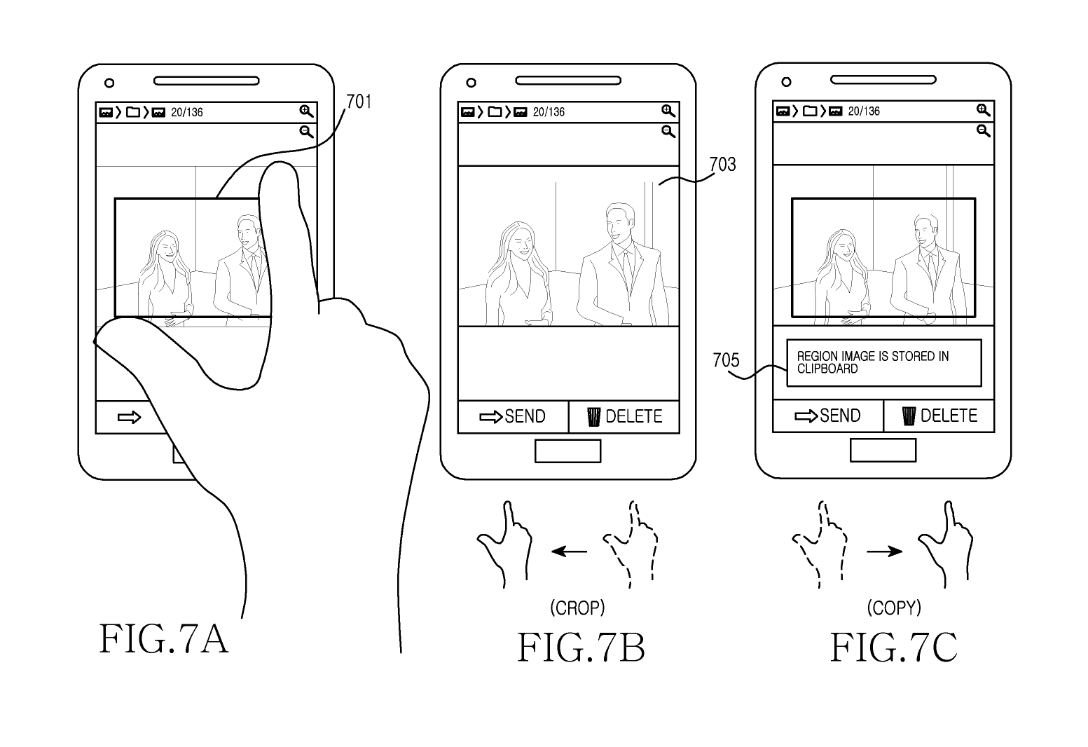

FIGS. 7A-7C illustrates a process of editing data of an electronic device according to an embodiment of the present invention.

FIG. 7A illustrates a screen which determines an edit region for an output screen in an electronic device of the present invention.

Referring to FIG. 7A, the electronic device determines an edit region 701 corresponding to a detected user input. As illustrated, an edit region in a shape of a quadrilateral corresponding to a user input point is determined in an output screen of the electronic device. Although the shape of the edit region illustrated in FIG. 7A has a quadrilateral shape, since the edit region is based on a user input point according to the present invention, the edit region can be determined in various other shapes. In addition, a shape of the edit region can be determined by the user. For example, the user predetermines a triangle shape, and thereafter if two points are touched as a user input, the electronic device may determine an edit region in a shape of a triangle having a side connecting the two points.

FIG. 7B and FIG. 7C illustrate a screen which edits data of an edit region in an electronic device of the present invention.

The electronic device can perform an editing process corresponding to a user input in a state in which the edit region is determined. For example, the editing process is an operation of cropping only data of the edit region from an output screen or an operation of storing the data of the edit region into a clipboard.

First, if it is confirmed that a touch is moved to the left in a state in which the edit region is determined as illustrated in FIG. 7B, the electronic device crops the data of the edit region (703).

In addition, if it is confirmed that a touch is moved to the right in a state in which the edit region is determined as illustrated in FIG. 7C, the electronic device stores the data of the edit region into the clipboard to copy the data. In this case, the electronic device can output a message 705 for reporting that the data of the edit region is stored into the clipboard.

The data editing process for the edit region described above with reference to FIG. 7 can be determined by the user. That is, although it is illustrated herein that the editing process is a crop and copy operation, it is also possible to associate a specific application with the data of the edit region according to a user determination. Such an operation can be one example of the editing process.

In addition, although it is described above with reference to FIG. 7 that a movement to the left and a movement to the right are exemplified as a request for performing a predetermined editing process, such an instruction can also be determined by a user (i.e., a movement direction can be changed). In addition, such an instruction can be generated by an input of a button and a menu provided in the electronic device in addition to a touch movement.

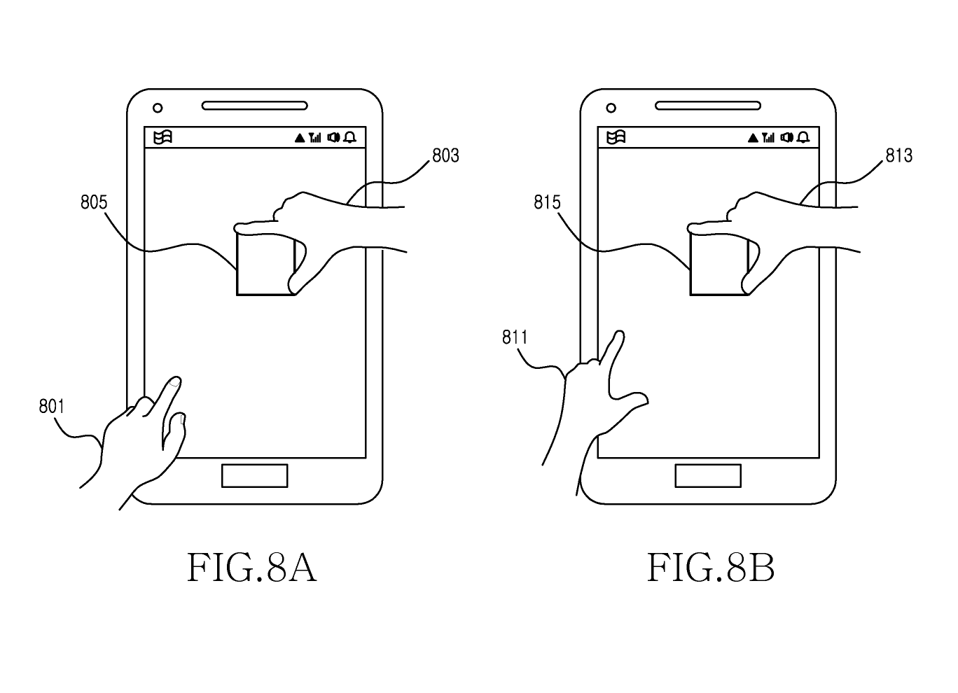

FIGS. 8A and 8B illustrate a screen which determines an edit region of an electronic device according to an embodiment of the present invention.

The electronic device can determine an edit region by using a user input according to the present invention.

For example, upon detection of a user touch input for two points, the electronic device can determine an edit region having a diagonal line connecting the two points.

In this case, the electronic device can detect a user input for concurrently selecting a plurality of points or can, alternatively, detect consecutive user inputs for a specific time period.

In general, an operation corresponding to the user input for selecting the plurality of points can be predetermined in the electronic device. For example, upon detection of the user input for the plurality of points, the electronic device can perform an operation of zooming in or out an output screen to a specific size.

In addition, upon detection of the consecutive user inputs for the specific time period, the electronic device can perform the operation of zooming in or out the output screen to a previous size.

Accordingly, the electronic device of the present invention determines the edit region or the control a size of the output screen according to a situation of a user input for determining the edit region.

That is, the electronic device of the present invention may determine the edit region upon detection of the user input for the plurality of points as illustrated in FIG. 4 to FIG. 7 described above, or may determine the edit region upon detection of a user input and a trigger signal for determining the edit region.

Herein, the trigger signal is input within a specific time period and is a request for determining the edit region. The trigger signal can be generated by a touch input for a predetermined touch screen and a hardware button input such as a volume key.

FIG. 8A illustrates a screen which determines an edit region by using a user input for three points. Herein, the user inputs for the three points are defined as a first input, a second input, and a third input according to an input order.

That is, the electronic device can define the first input as an input for generating a trigger signal.

Accordingly, the electronic device can detect a first input 801, and thereafter can determine an edit region 805 by using second and third inputs 803 which are detected consecutively.

FIG. 8B illustrates a screen which determines an edit region by using a user input for four points. Herein, the user inputs for the four points are defined as a first input, a second input, a third input, and a fourth input according to an input order.

That is, the electronic device can define the first input and the second input as an input for generating a trigger signal.

This prevents an unintentional user input from being recognized as the input for generating the trigger signal. For example, if a user grabs an electronic device having a large screen such as a tablet, an input may be generated on a part of the screen irrespective of a user's intention.

In this case, in order to clearly distinguish a user input for generating a trigger signal, the electronic device uses a plurality of inputs as the input for generating the trigger signal.

For example, the electronic device may detect first and second inputs 811 either consecutively or concurrently, and thereafter may determine an edit region 815 by using third and fourth inputs 813. A plurality of inputs are used in FIG. 8B in order to more correctly determine the input for generating the trigger signal than in the case of FIG. 8A.

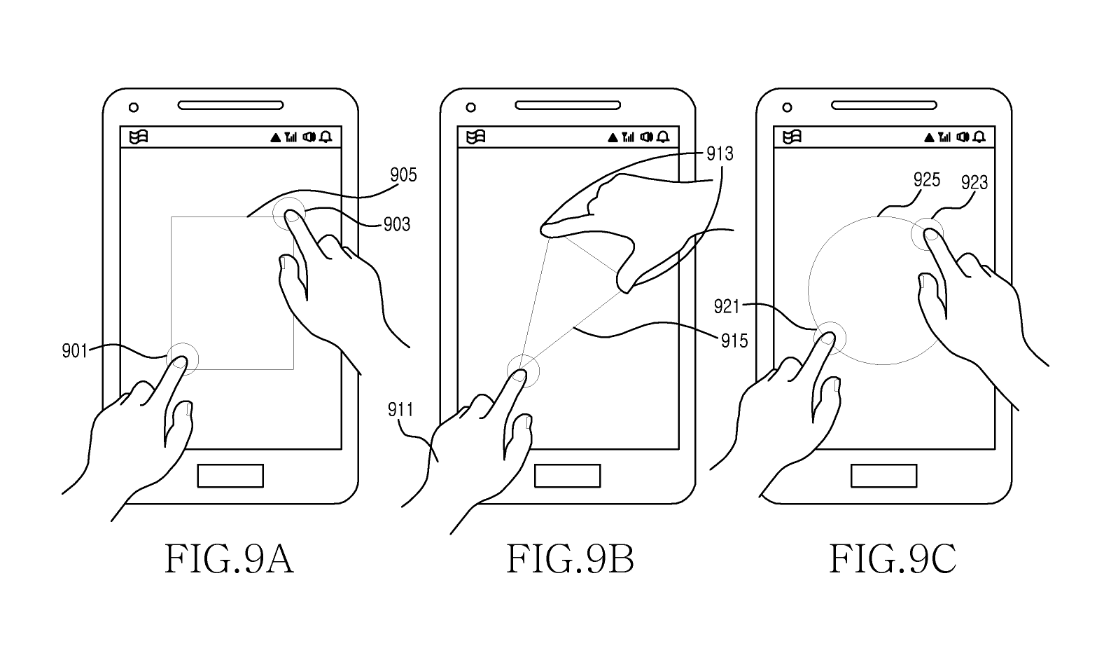

FIGS. 9A-9C illustrate a shape of an edit region which can be determined in an electronic device according to an embodiment of the present invention.

As described above, the electronic device of the present invention can determine an edit region by using points on which a user input is detected. In this case, the electronic device can determine the edit region by detecting a user input of at least two points.

FIG. 9A illustrates a screen which determines an edit region in a shape of a quadrangle in an electronic device of the present invention.

Referring to FIG. 9A, the electronic device detects a user input for a first input point 901 and a second input point 903 and determines a quadrilateral-shaped edit region 905 by using the two points.

In this case, the electronic device can determine an edit region having a diagonal line connecting two points as illustrated. In another example, the electronic device can determine an edit region in a shape of a square having a side connecting two points.

FIG. 9B illustrates a screen which determines an edit region in a shape of a triangle in another electronic device of the present invention.

Referring to FIG. 9B, the electronic device detects a user input for a first input point 911 and second and third input points 913, and determines a triangular-shaped edit region 915 by using the three points.

In this case, the electronic device can determine an edit region having vertices corresponding to the respective points as illustrated.

FIG. 9C illustrates a screen which determines an edit region in a shape of a circle in another electronic device of the present invention.

Referring to FIG. 9C, the electronic device detects a user input for a first input point 921 and a second input point 923 and determines a circular-shaped edit region 925 by using the two points. It should be noted, however, that the electronic device can determine the edit region by detecting a user input for two or more points.

In this case, the electronic device can determine an edit region having a diameter connecting two points as illustrated. In another example, the electronic device can determine an edit region having a radius connecting two points.

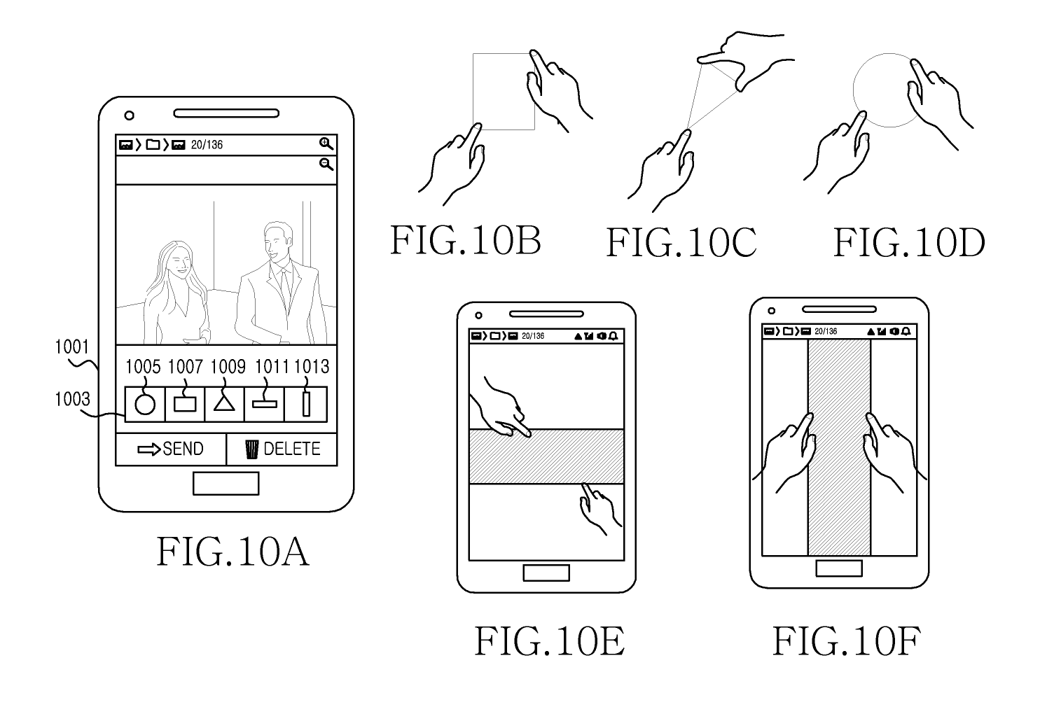

FIGS. 10A-10F illustrate a screen which performs a process of editing an image in an electronic device according to an embodiment of the present invention.

Referring to FIG. 10, the electronic device can determine an edit region in a state in which an image edit function is executed.

First, the electronic device 1001 provides a list 1003 of shapes for a shape of the edit region as illustrated in FIG. 10A to allow a user to select the shape of the edit region.

That is, if the user selects the shape of the edit region and thereafter performs a touch input, the electronic device can determine an edit region in the shape selected based on points on which a user input is detected.

Examples of the shape of the edit region of FIG. 10A include a circle 1005, a quadrilateral 1007, a triangle 1009, a horizontal line 1011, and a vertical line 1013.

FIG. 10B illustrates a situation in which an edit region having a quadrilateral shape is determined based on a user input.

FIG. 10C illustrates a situation in which an edit region having a triangle shape is determined based on a user input.

FIG. 10D illustrates a situation in which an edit region having a circle shape is determined based on a user input.

FIG. 10E illustrates a situation in which an edit region having a horizontal line shape is determined based on a user input. Herein, the horizontal line shape is a region selected between a first input point and a second input point in an edit region, and a user determines only a horizontal axis region (i.e., top and bottom parts).

FIG. 10F illustrates a situation in which an edit region having a vertical line shape is determined based on a user input. Herein, the vertical line shape is a region selected between a first input point and a second input point in an edit region, and a user determines only a vertical axis region (i.e., left and right parts).

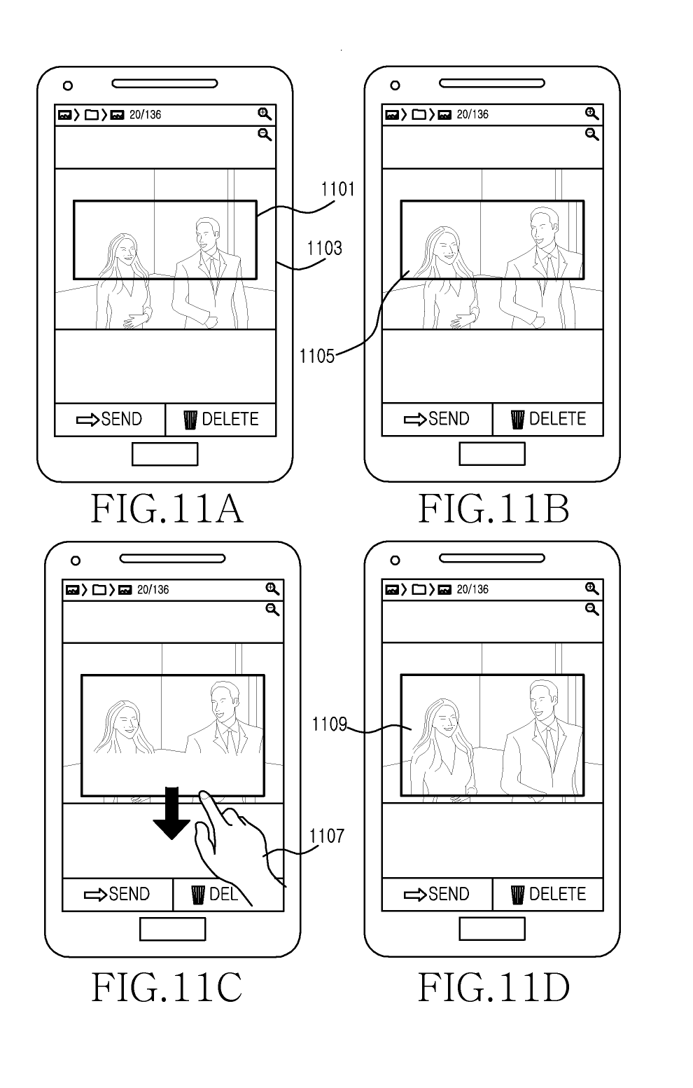

FIGS. 11A-11D illustrate a screen which controls a size of an edit region in an electronic device according to an embodiment of the present invention.

First, the electronic device determines an edit region by detecting a user input. In this case, the electronic device determines the edit region by detecting a plurality of user inputs as described above. The electronic device may detect an input of a trigger signal for determining the edit region according to an embodiment of the present invention, and thereafter may determine the edit region by using consecutively detected user inputs.

A screen in which an edit region 1101 for an output screen 1103 is determined is illustrated in FIG. 11A. The electronic device can change a size and location of a predetermined edit region on the basis of a user input according to the present invention. This is because it is difficult to determine an edit region desired by a user at one time by using a user input, and thus a size and location of the determined edit region is changed. In order to enable such an operation, the electronic device activates a function for changing the size and location of the edit region when the edit region is determined. For example, the electronic device outputs an icon at a side or corner of a predetermined edit region to enable the change in the size and location thereof. Thus, the user can change the size or location of the edit region by selecting an icon of a corresponding part.

In addition, the electronic device outputs data (or an image) included in a determined edit region by zooming in the data (1105) in an output screen according to an embodiment of the present invention as illustrated in FIG. 11B. In general, the user crops or copies only a desired part in the output screen. Although the edit region desired by the user can be determined by changing the size or location of the predetermined edit region as described above, it may be difficult to precisely determine the edit region using this method.

Accordingly, the electronic device can output a screen by zooming in a part which is determined as an edit region in an output screen as illustrated in FIG. 11B. In this case, the electronic device zooms in only a part of the output screen. The electronic device can zoom in on data included in the edit region or can zoom in on only an edge part of the edit region.

Accordingly, the user can confirm whether the edit region is determined desired by the user by using a zoomed-in part.

That is, the user generates an input for changing a size or location of the edit region in a state in which the edit region including the zoomed-in screen is output as illustrated in FIG. 11B. That is, in order for the user to extend the size of the edit region in a down direction as illustrated in FIG. 11C, an input 1107 is generated to move down only a lower part of a predetermined edit screen. In this case, the electronic device extends the edit region in a downward direction, and outputs the extended area by also zooming it in.

The changed edit region 1109 is illustrated in FIG. 11D.

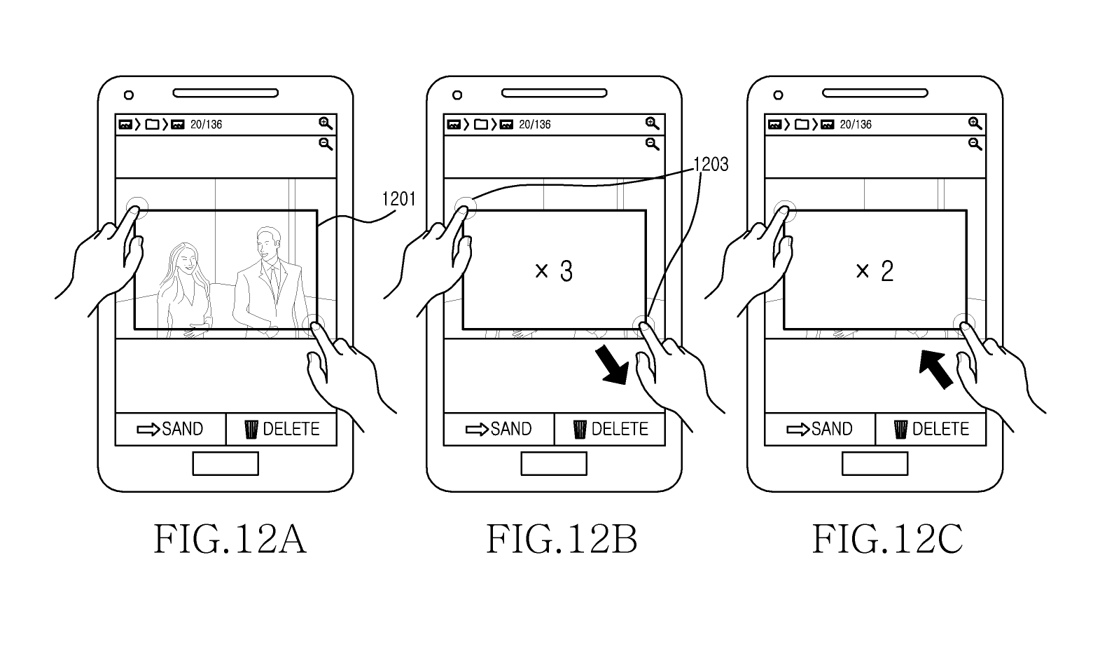

FIGS. 12A-12C illustrate a screen which controls data of an edit region in an electronic device according to an embodiment of the present invention.

Referring to FIG. 12, the electronic device can determine an edit region by detecting a user input detected on an output screen. Herein, the edit region may be a region to be cropped from the output screen. Alternatively, the edit region may be a region to be copied or deleted from the output screen. That is, the edit region refers to a part selected from the output screen.

FIG. 12A illustrates a screen in which an edit region is determined by detecting a user input in the aforementioned electronic device. Although an edit region 1201 having a quadrilateral shape is determined for the output screen illustrated herein, the electronic device of the present invention can change the shape of the edit region according to the user input.

Upon determining the edit region as described above, the electronic device can zoom in or out on data of the edit region in a specific ratio according to the user input.

That is, if the user generates an input for extending a size of a predetermined edit region as illustrated in FIG. 12B, the electronic device can zoom in data of the edit region in a predetermined ratio according to a detected user input 1203. In the screen illustrated herein, the data included in the edit region of FIG. 12A is zoomed in 3 times.

In this case, the user zooms in on the data of the edit region by selecting and moving an edge of the edit region as illustrated. In this case, the electronic device zooms in on only the data of the edit region while maintaining the size of the predetermined edit region. In addition, in another example, the electronic device zooms in on the data of the edit region while extending the size of the edit region.

In addition, if the user generates an input for decreasing the size of the predetermined edit region as illustrated in FIG. 12C, the electronic device zooms out the data of the edit region in a predetermined ratio according to the detected user input. In the screen illustrated herein, the data of FIG. 12B, which is zoomed in from the data of FIG. 12A, is zoomed out two times.

The user zooms out the data of the edit region by selecting and moving an edge of the edit region as illustrated. The electronic device zooms out only the data of the edit region while maintaining the size of the predetermined edit region. In addition, in another example, the electronic device zooms out the data of the edit region while decreasing the size of the edit region.

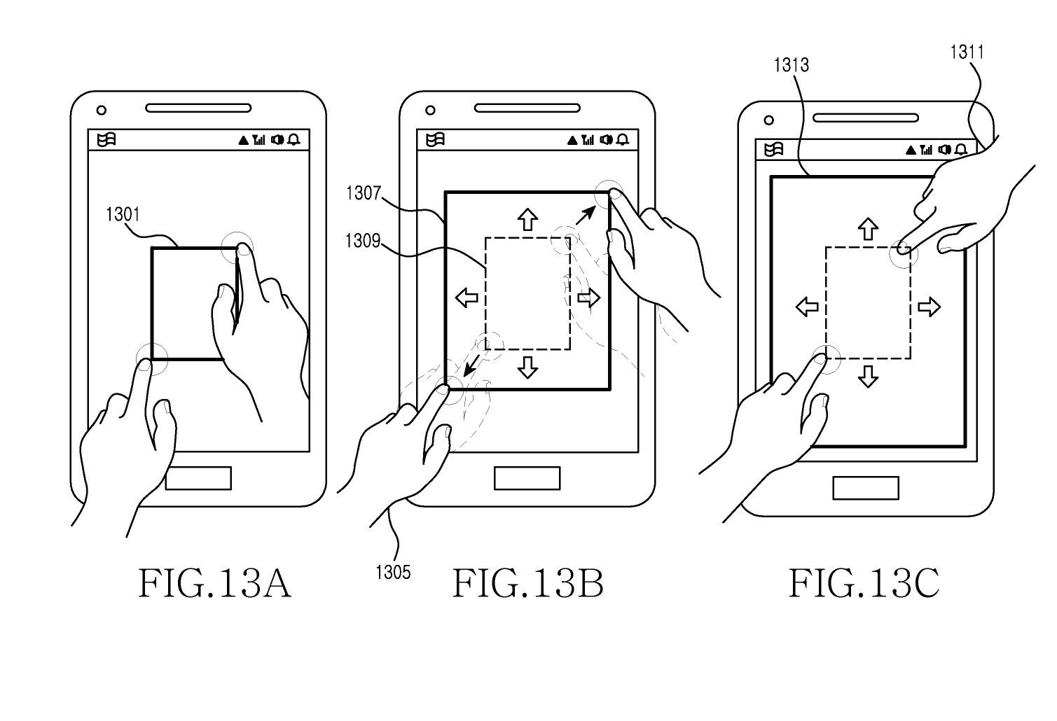

FIGS. 13A-13C illustrates a screen which controls a size of an edit region in an electronic device according to an embodiment of the present invention.

Referring to FIG. 13, the electronic device can determine an edit region by detecting a user input detected on an output screen. Herein, the edit region may be a region to be cropped from the output screen. Alternatively, the edit region may be a region to be copied or deleted from the output screen. That is, the edit region refers to a part selected from the output screen.

FIG. 13A illustrates a screen in which an edit region 1301 is determined by detecting a user input in the aforementioned electronic device. Although an edit region having a quadrangle shape is determined on the output screen illustrated herein, the electronic device of the present invention can change the shape of the edit region according to the user input.

Upon determination of the edit region as described above, the electronic device can increase or decrease a size of the edit region in a specific ratio according to the user input.

That is, if the user generates an input 1305 for increasing a size of a predetermined edit region as illustrated in FIG. 13B, the electronic device can zoom in (1309) an edit region 1307 in a predetermined ratio according to a detected user input. In the screen illustrated herein, the edit region of FIG. 13A is zoomed in according to a touch movement of the user.

In this case, the user can zoom in the edit region by selecting and moving an edge of the edit region as illustrated.

In addition, if the user generates an input for decreasing a size of a predetermined edit region, the electronic device can zoom out the edit region in a predetermined ratio according to a detected user input.

In addition, if the user maintains (with long press) an input part for a predetermined time period (1311) to determine an edit region as illustrated in FIG. 13C, the electronic device can re-determine the predetermined edit region to a full output screen (1313). Herein, the input for re-determining the predetermined edit region to the full output screen can be defined in a different manner in addition to the long-pressing of the input for the predetermined time period.

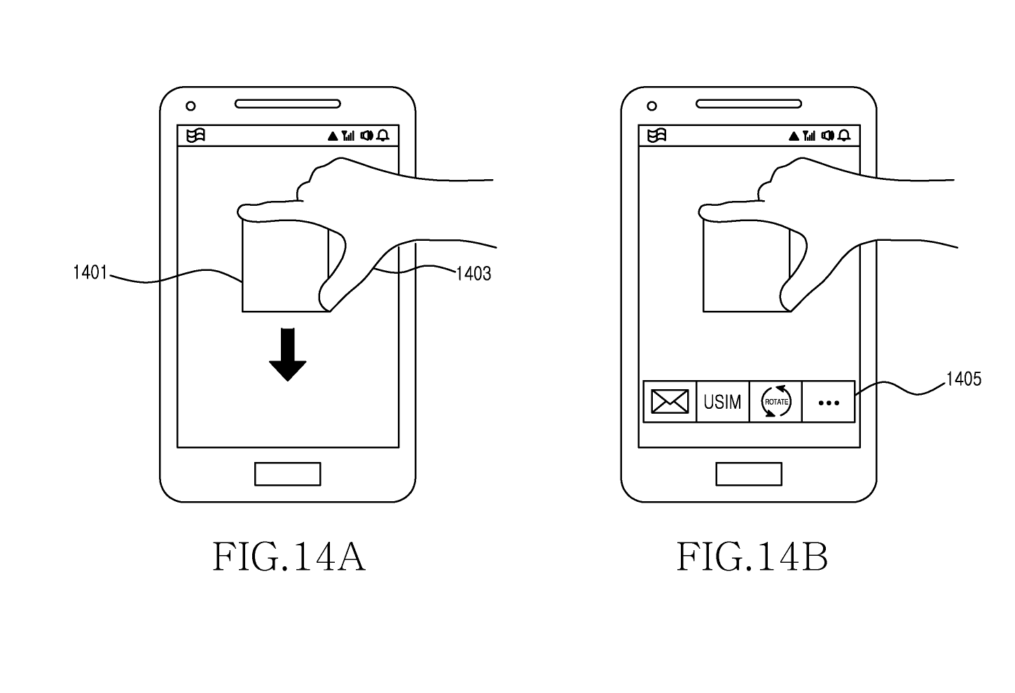

FIGS. 14A and 14B illustrate a screen which controls an edit region in an electronic device according to an embodiment of the present invention.

Referring to FIG. 14, the electronic device can determine an edit region 1401 by using a user input detected on an output screen. In general, a user can determine the edit region to crop or copy an image. Herein, a crop or copy operation using the edit region is defined as a representative operation for an edit screen. Accordingly, the electronic device of the present invention can perform the representative operation by using a user input for a predetermined edit region.

For example, if it is confirmed that a touch is moved to the left in a state in which the edit region is determined, the electronic device crops the data of the edit region.

In addition, if it is confirmed that a touch is moved, for example, to the right in a state in which the edit region is determined, the electronic device stores the data of the edit region into the clipboard to copy the data.

Further, the electronic device of the present invention can perform an additional operation by using a user input in addition to the representative operation in the edit region.

That is, if a user input 1403 on which the representative operation is not determined for the edit region 1401 is detected as illustrated in FIG. 14A, for example, if it is confirmed that a touch movement occurs in a down direction, the electronic device can output a list 1405 for an additional function as illustrated in FIG. 14B. It is illustrated herein that the additional function list 1405 includes a function for attaching data of the edit region to a message, storing the data of the edit region into an additional storage space such as a Universal Subscriber Identify Module (USIM), and rotating the data of the edit region. In addition, a function included in the additional function list can be determined by the user.

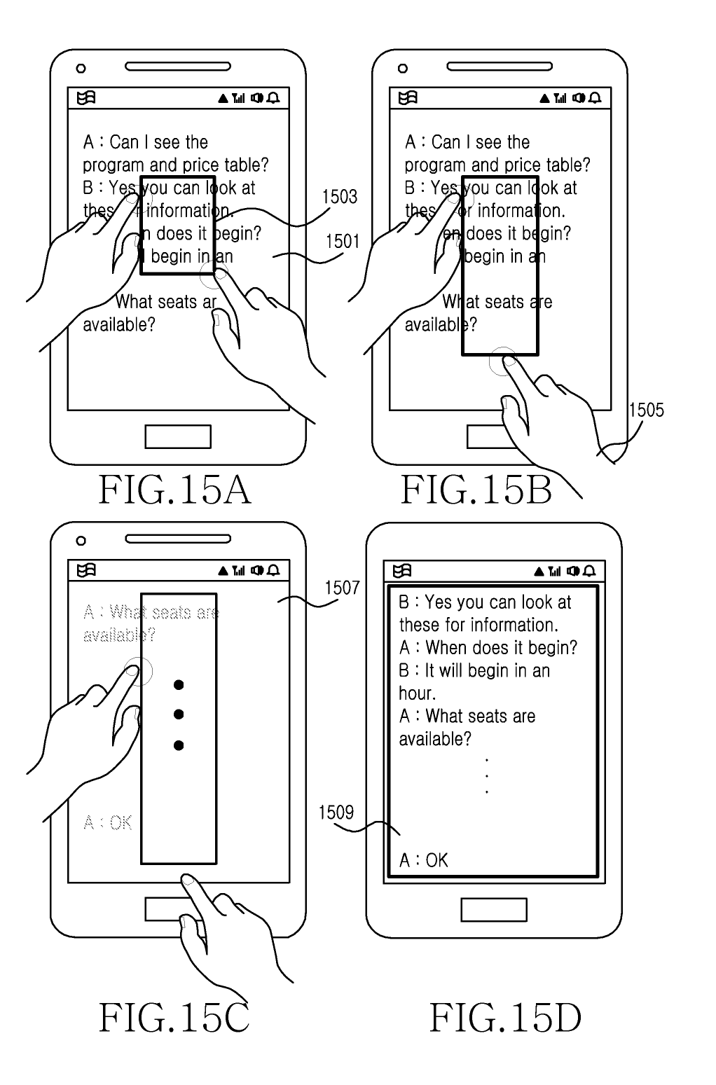

FIGS. 15A-15D illustrate a screen which zooms in an edit region in an electronic device according to an embodiment of the present invention.

Referring to FIG. 15, the electronic device can zoom in on a predetermined edit region by using a user input for the edit region as described above. That is, the user can zoom in or out the predetermined edit region while increasing or decreasing a size of an edge of the edit region by a touch movement.

However, this method may have difficulty in the control of the edit region when a page of an output screen is changed. For example, the edit region can be determined on a part of a current output screen while increasing or decreasing a size of an edge of a predetermined edit region in a state in which a web screen or an e-book is executed. However, it is difficult to control a size of the edit region by using the edge of the edit region in a situation in which a page is consecutively changed to the extent of being out of the current output screen.

In order to solve the aforementioned problem, the electronic device of the present invention determines an edit region 1503 on an output screen 1501 as illustrated in FIG. 15A, and thereafter detects a user input 1505 for moving an edge of a predetermined edit region to a specific location as illustrated in FIG. 15B.

In this case, the electronic device changes the current output screen to the extent of a specific range as illustrated in FIG. 15C. That is, the electronic device performs a line feed of the output screen until the user input is released. In this case, the electronic device continously determines the edit region on an output screen 1507 on which a line feed is performed.

That is, the electronic device stops the process of changing the output screen at a time of releasing the user input as illustrated in FIG. 15D, and determines an edit region until a time of releasing the user input (1509).

Referring to FIG. 15A to FIG. 15D, the user moves a touch to a bottom part of the output screen in a state in which the edit region is determined around a sentence of “B: Yes. You can look at . . . ”.

Accordingly, the electronic device extends the edit region to up to a point of “A: What seats are available?” of the current output screen. Thereafter, if it is confirmed that the user input for the bottom part of the output screen is not released, the electronic device outputs a screen on which contents are changed due to a line feed, and thereafter determines the edit region to up to a point of “A: OK” at which the user input is released.

This implies that the user can also determine contents not displayed in the current output screen as the edit region while maintaining the touch input. This can be useful in a situation in which the web screen or e-book consisting of a plurality of pages is executed as described above.

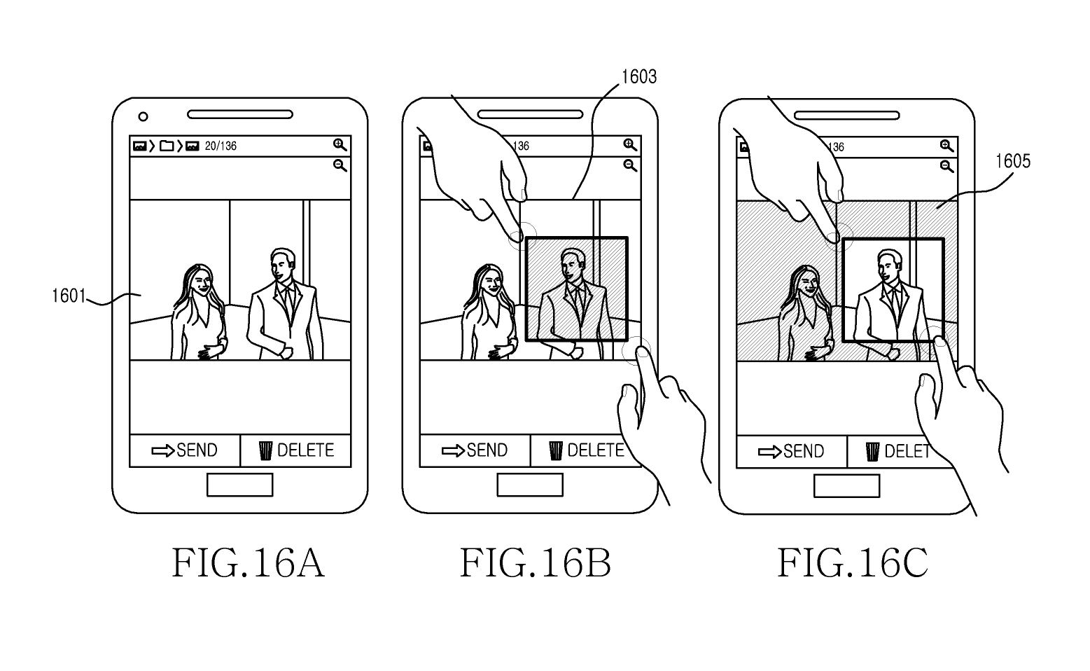

FIGS. 16A-16C illustrate a screen which reverses an edit region in an electronic device according to an embodiment of the present invention.

First, a user of the electronic device can determine the edit region to crop or copy a specific part of an output screen. Alternatively, the user can determine the edit region to crop or copy the remaining parts other than the specific part from the output screen.

In general, the electronic device determines the edit region by using a point at which a user input is detected.

That is, as illustrated in FIG. 16A, when the electronic device outputs an image 1601 including a male image and a female image, if the user determines an edit region only for the male image, the user touches a point around the male image as a user input as illustrated in FIG. 16B. Accordingly, the electronic device determines an edit region 1603 around a point at which the touch input of the user is detected.

Alternatively, if the user determines the edit region only for the female image, the user touches a point around the female image as a user input.

However, it is difficult for the user to determine the edit region only for a region excluding the male image. Of course, the edit region can be extended while changing a shape of the edit region by a multi-touch input. However, an input process must be performed multiple times to correctly determine the region excluding the male image.

In order to solve the aforementioned problem, the electronic device of the present invention can reverse the edit region by detecting a user input for a predetermined edit region.

That is, the electronic device can reverse the edit region (1605) for a part excluding a region selected by the user.

The shadow part of FIG. 16B indicates an edit region which is determined by the user, and the shadow part of FIG. 16C indicates an edit region after reversal by the user.

Although the electronic device of the present invention can perform the aforementioned operations by using a program stored in a memory, according to the present invention, the electronic device can include a means for detecting a user input of at least two points on an output screen and a means for determining an edit region including points on which the user input is detected.

The aforementioned means may be configured in separate hardware components or may be configured in one hardware component.

According to an electronic device for determining an edit region by using a touch input and a method thereof provided in an embodiment of the present invention, there is an advantage in that the edit region can be determined in a state of skipping a process of navigating through a plurality of menus of the electronic device and in that different shapes of edit regions can be determined based on a user input.

While the present invention has been particularly shown and described with reference to embodiments thereof, it will be understood by those skilled in the art that various changes in form and details may be made therein without departing from the spirit and scope of the present invention as defined by the appended claims.

What is claimed is:

1. A method of determining an edit region of an output screen in an electronic device, the method comprising:
detecting a user input of at least two points on the output screen; and
determining the edit region as a function of the points on which the user input is detected.

2. The method of claim 1, wherein the edit region includes a region for selecting a part of an output full screen.

3. The method of claim 1, wherein determining the edit region comprises determining the edit region in a shape determined by a user, wherein the shape determined by the user is one of a quadrilateral, a triangle, and a circle.

4. The method of claim 1, wherein determining the edit region comprises zooming in on data included in the edit region.

5. The method of claim 1, wherein determining the edit region comprises reversing a predetermined edit region according to the user input.

6. The method of claim 1, further comprising changing at least any one of a shape, size, and location of a predetermined edit region by detecting the user input.

7. The method of claim 1, further comprising editing data included in the edit region according to the user input for a predetermined edit region, wherein the editing of the data included in the edit region is at least one of data cropping, data storing, data copying, data selecting, and data attaching.

8. The method of claim 1, wherein detecting the user input for the at least two points on the output screen comprises determining whether at least one input among the detected user inputs is a request for determining the edit region.

9. An apparatus for determining an edit region of an output screen in an electronic device, the apparatus comprising:
at least one processor;
a memory; and
at least one program stored in the memory and configured to be executable by the at least one processor,
wherein the program includes an instruction for detecting a user input of at least two points on the output screen and for determining the edit region as a function of the points on which the user input is detected.

10. The apparatus of claim 9, wherein the program includes an instruction for determining an edit region for selecting a part of an output full screen.

11. The apparatus of claim 9,
wherein the program includes an instruction for determining the edit region in a shape determined by a user, and
wherein the shape determined by the user is one of a quadrilateral, a triangle, and a circle.

12. The apparatus of claim 9, wherein the program includes an instruction for zooming in on data included in the edit region.

13. The apparatus of claim 9, wherein the program includes an instruction for reversing a predetermined edit region according to the user input.

14. The apparatus of claim 9, wherein the program includes an instruction for changing at least any one of a shape, size, and location of a predetermined edit region by detecting the user input.

15. The apparatus of claim 9,
wherein the program includes an instruction for editing data included in the edit region according to the user input for a predetermined edit region, and
wherein the instruction for editing the data included in the edit region includes at least one of data cropping, data storing, data copying, data selecting, and data attaching.

16. The apparatus of claim 9, wherein the program includes an instruction for determining whether at least one input among a plurality of detected user inputs is a request for determining the edit region.

17. A non-transitory computer-readable storage medium for storing one or more programs, which include instructions that allow an electronic apparatus to perform a method comprising the steps of:
detecting a user input of at least two points on an output screen of the electronic apparatus; and
determining an edit region as a function of the points on which the user input is detected.
